(19) United States
(12) Patent Application Publication
(10) Pub. No.: US 2019/0344122 A1
(43) Pub. Date: Nov. 14, 2019

(54) REFERENCE POINT GENERATION AND USING SAID POINT TO ENABLE HARMONIC ENERGY BASED ACTION OF USER

(71) Applicant: Akshaya PANDIT, New Delhi OT (IN)

(72) Inventor: Akshaya PANDIT, New Delhi (IN)

(21) Appl. No.: 16/307,494

(22) PCT Filed: May 8, 2017
(86) PCT No.: PCT/IB2017/052664

§ 371 Date: Dec. 6, 2018

(30) Foreign Application Priority Data
Jun. 7, 2016 (IN) 201611019487

(51) Int. Cl. A63B 24/00; G06F 3/01; G09B 19/00

(52) U.S. Cl. CPC A63B 24/0075; A63B 24/0062; G06F 3/011; G09B 19/0038; A63B 2024/0078; A63B 2220/836; G09B 19/003

(57) ABSTRACT

The present disclosure relates to a method of deriving a reference point and using said reference point to enable harmonic energy based action by a user, said method comprising the steps of: receiving, at a computing device, data pertaining to any or a combination of an orientation or an action performed by the user by means of at least one sensor configured on the user; and deriving, at the computing device, the reference point based on the received data and a metronome in a manner such that achievement of the reference point by the user during the orientation/action enables creation of shortest path for energy delivery with positive polarity.

### FIELD OF DISCLOSURE

The present disclosure relates to a system and method of deriving a reference point, and using the reference point to enable harmonic energy based action by a user.

### BACKGROUND OF THE DISCLOSURE

The background description includes information that may be useful in understanding the present invention. It is not an admission that any of the information provided herein is prior art or relevant to the presently claimed invention, or that any publication specifically or implicitly referenced is prior art.

Existing techniques for biomechanics create stress and time latency in the form and function of a person/user, which results in various multiple issues such as injury of body and inefficiency of action and skewed musculo-skeletal relationships.

There is therefore a need for a system and method that enables determination of a reference point (RP) and use thereof to enable users to take biomechanical actions in a result-oriented stresslessness (or efficient energy functional) manner.

All publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

In some embodiments, the numbers expressing quantities or dimensions of items, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

### OBJECTS OF THE INVENTION

An object of the present disclosure is to provide a system and method that enables generation/derivation of a reference point (RP).

An object of the present disclosure is to provide a system and method that enables use of the RP to enable harmonic energy based action by a user.

An object of the present disclosure is to provide a system and method that enables use of the RP in a harmonic energy implementation system.

Another object of the present disclosure is to produce designs for products in keeping with the reference point so as to create medical/physiotherapy/sporting/artificial limb/organ products.

Another object of the present disclosure is to produce designs for products that apply the RP for creating new products and technology especially for clean energy/free energy/perpetual energy/efficient energy.

Another object of the present disclosure is to design products that can be made to harmonize with chaos theory or butterfly effect or at-least make it efficient and allow for analysis of the same and associated parameters.

Yet another object of the present disclosure is to design products that allow for analog to digital conversion and digital to analog conversion to be optimized along with processing for the analog/digital/domain based functioning.

Yet another object is to produce products that form parts of products to be made harmonized for form and function and energy and intelligence (safety/etc.).

Yet another object is to produce products that enable creation of medical data and corrections and make precise medical concepts and data as regards the various relationships between musculoskeletal/biomechanical/mental/energetic/intelligence relationships with regards to efficiency and their reorganization/reorientation/s and thus reflecting in human experience/relationship to time and memory and so on.

Yet another object is to enable scaling up and down of the RPas regards matter/energy/intelligence/etc and it's organization for various application/s.

### SUMMARY OF THE INVENTION

In an aspect, the present disclosure relates to a method of deriving a reference point (also interchangeably referred to as a “reference system” hereinafter) and using said reference point to enable harmonic energy based action by a user, said method comprising the steps of: receiving, at a computing device, data pertaining to any or a combination of an orientation or an action performed by the user by means of at least one sensor configured on the user; and deriving, at the computing device, the reference point based on the received data and a metronome in a manner such that achievement of the reference point by the user during the orientation/action enables creation of shortest path for energy delivery with positive polarity.

In an aspect, the orientation is any or a combination of foot orientation, hand orientation, punching pathway orientation, shot-making pathway orientation, and energy orientation.

In an aspect, the action is any or a combination of punching action, hand-based action, body-based action, and foot-based action.

In another aspect, the reference point can be used for deriving a tempo, wherein time signature of the tempo is changed in a linear fashion, wherein the change in the time signature in the linear fashion allows for the orientation/action to be broken down into a plurality of steps within the same tempo, and wherein sequential increase in the time signature with reference to the tempo and with reference to the completed action signifies a phase-relationship of energy flow. In another aspect, the derived tempo can be used as a training reference for creating computer-enabled programs with variations to exercise patterns and/or training tempo for one or more levels of training for learning and improving form and function. In yet another aspect, the tempo can be inter-sectional or vector-based.

In an aspect, phase relationship created by the positive polarity enables a repeatedly efficient form and function that allows for energy/phase relationships to be manipulated/re-routed for a desired application.

In another aspect, the data can pertain to any or a combination of a sporting action, musical action, fitness based action, and physiotherapy based action.

In an aspect, the reference point can be 88, wherein the reference point can be used to help derive a fundamental unit for a product design application, and wherein the product design relates to any or a combination of sporting product, a fitness product, an ergonomic product design, a vehicle design, a sound and light equipment design, a furniture design, an interconnecting device design, an antenna design.

In an aspect, the reference point can be used for training users with respect to their actions and/or orientations. In another aspect, the data can be simulated data.

Various objects, features, aspects and advantages of the present disclosure will become more apparent from the following detailed description of preferred embodiments, along with the accompanying drawing figures in which like numerals represent like features.

### BRIEF DESCRIPTION OF DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

The diagrams are for illustration only, which thus is not a limitation of the present disclosure, and wherein:

FIG. 1 illustrates an exemplary implementation architecture of the proposed system in accordance with an embodiment of the present disclosure.

FIG. 2 illustrates exemplary functional modules for enabling derivation of reference point in accordance with an embodiment of the present disclosure.

FIG. 3 illustrates an exemplary flow diagram for enabling derivation of reference point in accordance with an embodiment of the present disclosure.

FIG. 4 illustrates an exemplary computer system in which or with which aspects of the present disclosure can be implemented.

FIG. 5 illustrates an exemplary product that has been developed based on reference point computation in accordance with an aspect of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

Embodiments of the present invention include various steps, which will be described below. The steps may be performed by hardware components or may be embodied in machine-executable instructions, which may be used to cause a general-purpose or special-purpose processor programmed with the instructions to perform the steps. Alternatively, steps may be performed by a combination of hardware, software, and firmware and/or by human operators.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Exemplary embodiments will now be described more fully hereinafter with reference to the accompanying drawings, in which exemplary embodiments are shown. This invention may, however, be embodied in many different forms and should not be construed as limited to the embodiments set forth herein. These embodiments are provided so that this disclosure will be thorough and complete and will fully convey the scope of the invention to those of ordinary skill in the art. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition persons in the pertinent art have given that term as reflected in printed publications and issued patents at the time of filing

In an aspect, the present disclosure relates to a method of deriving a reference point (also interchangeably referred to as a “reference system” hereinafter) and using said reference point to enable harmonic energy based action by a user, said method comprising the steps of: receiving, at a computing device, data pertaining to any or a combination of an orientation or an action performed by the user by means of at least one sensor configured on the user; and deriving, at the computing device, the reference point based on the received data and a metronome in a manner such that achievement of the reference point by the user during the orientation/action enables creation of shortest path for energy delivery with positive polarity.

In an aspect, the orientation is any or a combination of foot orientation, hand orientation, punching pathway orientation, shot-making pathway orientation, and energy orientation.

In an aspect, the action is any or a combination of punching action, hand-based action, body-based action, and foot-based action.

In another aspect, the reference point can be used for deriving a tempo, wherein time signature of the tempo is changed in a linear fashion, wherein the change in the time signature in the linear fashion allows for the orientation/action to be broken down into a plurality of steps within the same tempo, and wherein sequential increase in the time signature with reference to the tempo and with reference to the completed action signifies a phase-relationship of energy flow. In another aspect, the derived tempo can be used as a training reference for creating computer-enabled programs with variations to exercise patterns and/or training tempo for one or more levels of training for learning and improving form and function. In yet another aspect, the tempo can be inter-sectional or vector-based.

In an aspect, phase relationship created by the positive polarity enables a repeatedly efficient form and function that allows for energy/phase relationships to be manipulated/re-routed for a desired application.

In another aspect, the data can pertain to any or a combination of a sporting action, musical action, fitness based action, and physiotherapy based action.

In an aspect, the reference point can be 88, wherein the reference point can be used to help derive a fundamental unit for a product design application, and wherein the product design relates to any or a combination of sporting product, a fitness product, an ergonomic product design, a vehicle design, a sound and light equipment design, a furniture design, an interconnecting device design, an antenna design.

In an aspect, the reference point can be used for training users with respect to their actions and/or orientations. In another aspect, the data can be simulated data.

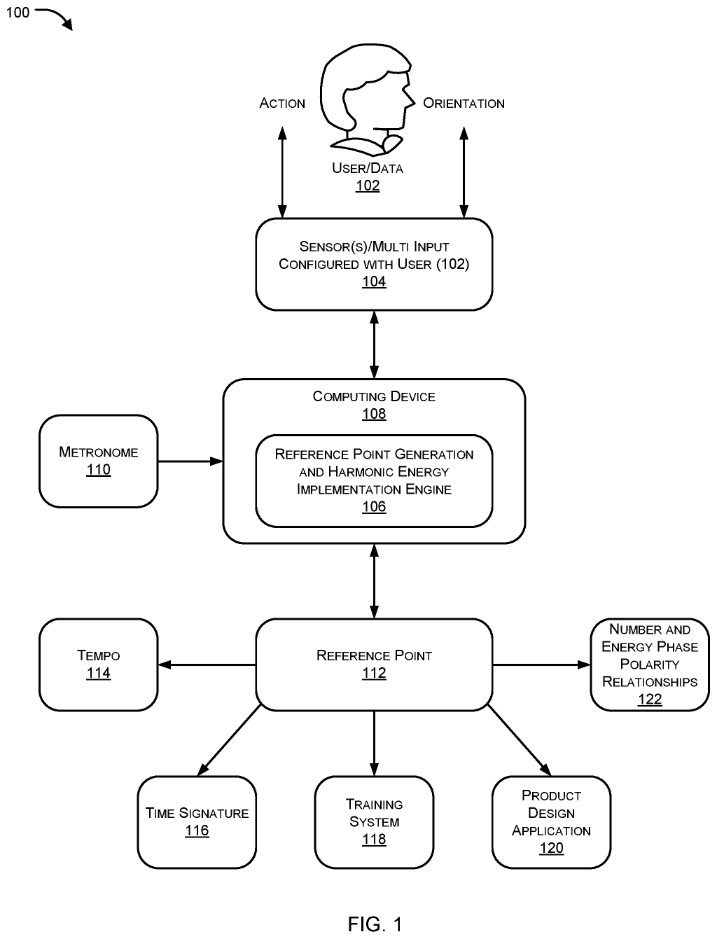

FIG. 1 illustrates an exemplary implementation architecture 100 of the proposed system in accordance with an embodiment of the present disclosure. As can be seen, the system 100 can include a user 102 that can be configured to take one or more actions or orientations while performing a physical function. In an aspect, the one or more actions can include, but are not limited to, punching action, hand-based action, body-based action, and foot-based action. Similarly, in another aspect, the orientation can include, but is not limited to, orientation is any or a combination of foot orientation, hand orientation, punching pathway orientation, shot-making pathway orientation, and energy orientation.

In an aspect, based on such actions and/or orientations, at least one sensor 104 of the present disclosure can be configured to receive data pertaining to the actions/orientations performed by the user 102, and transmit such received data to a reference point generation and harmonic energy implementation engine 106. In an aspect, the engine 106 can be configured in a computing device 108 such as a laptop, desktop PC, a server, cloud, mobile phone, etc, and can be further configured to derive, at the computing device 108, a reference point (RP) 112 based on the received data and a metronome 110 in a manner such that achievement of the RP 112 by the user 102 during the orientation/action enables creation of shortest path for energy delivery with positive polarity.

In an aspect, the RP 112 can be used for deriving a tempo 114, wherein time signature 116 of the tempo 114 can be changed in a linear fashion, and wherein the change in the time signature 116 in the linear fashion can allow for the orientation/action to be broken down into a plurality of steps within the same tempo 114, and wherein sequential increase in the time signature 116 with reference to the tempo 114 and with reference to the completed action signifies a phase-relationship of energy flow. In another aspect, the derived tempo 114 can be used as a training reference 118 for creating computer-enabled programs with variations to exercise patterns and/or training tempo for one or more levels of training for learning and improving form and function. In yet another aspect, the tempo 114 can be inter-sectional or vector-based.

In an aspect, phase relationship created by the positive polarity enables a repeatedly efficient form and function that allows for energy/phase relationships to be manipulated/re-routed for a desired application.

In an aspect, data received from actions/orientations of the user can pertain to any or a combination of a sporting action, musical action, fitness based action, and physiotherapy based action.

In an aspect, the RP 112 can have a value of “88”, wherein the RP 112 can be used to help derive a fundamental unit for a product design application 120, and wherein the product design 120 relates to any or a combination of, in a non-limitation matter, sporting product, a fitness product, an ergonomic product design, a vehicle design, a sound and light equipment design, a furniture design, an interconnecting device design, an antenna design.

In an aspect, RP 112 can further configured to enable derivation of number and energy phase polarity relationships 122.

In an aspect, the RP 112 can be used for training users with respect to their actions and/or orientations. In another aspect, the data can be simulated data.

In an aspect, system of the present disclosure enables generation of the RP 112 that can also be referred to as positive harmonic infinity, wherein such RP 112 allows for organization of intelligence and efficiency of form, function, and intelligence, largely supported by the loss of inefficient form function, energy, and intelligence and can be repeated based on the parameters to create repeatedly and successively improved form function and intelligence. Thus, the same progressions can be used to further improve design with regards to efficiency to allow for better aesthetics, safety standards, and resolutions of most issues face by designs not referenced to positive harmonic infinity. Thus, such a system removes most issues that are a by-product of designs not referenced to positive harmonic infinity.

In an aspect, the proposed system improves management of space within design for ergonomics, visual appeal, and also allows for human-like features to be derived from the system of design. The proposed system also be used for animation, speaker design, or audio system chain efficiency, and so on. As human is the best or most evolved design that has energy and intelligence and physically hard and soft parts along with perception, the RP of a human interacting with matter and energy efficiency is required and so RP can include all the parameters of a human such as energy/intelligence/form/function/perception or perceptional relationship to experience/ergonomical biomechanical relationships/etc. Thus when a RP is derived that organizes all these parameters for filed RP and the RP allows for systems to be created that have mathametical coherence with energy functioning phase/polarity relationships, one can use such maths/etc and apply it to geometary/etc, as the mathametical system is essentially based upon understanding the relationship of phase and polarity relationships with regards to understanding how orientations/parameters affect energy functionings, it is clear that the design thus created has the potential to now be decided in accordance to phase/polarity simply by choosing a number from the system or alternatively trying out various numbers until the desired function or asthetics are arrived at from within the system created by the RP.

As the RP is based/referenced upon human evolutionary & thus by default efficiency seeking (geometary&) functioning it not only makes experience coherent& better standardised and thus averagely more enjoyable/attention grabbing but also presents a standardized system where human like geometary/maths (RP) can be used in various ways to generate the size of the eyes for an animation/drawing and be able to be more efficient towards passing expressions for a scene, while being electrically coherent for production, thus from the drawing board to the screen one common mathametical/geometric/etc RP is created which helps not only the artistic creation process but also the production and delivery of the production at the cinema hall for the customer experience by functioning on a common RP from the drawing board by the artist/computer to the production master to the cinema screen/projector and audio and seating experience all being calibrated to the qualities of one common RP. (Thus the RP allows for artistic variables to be included and not just rigid design options for creating products). Thus for example that speaker cabinet size (geometry) and the placement of various components of the speaker frequency range can all be ideally made so that the eventual interactions of multiple speaker or of a single speaker with multiple components can all be made more efficient or coherent for the delivery and experience of the audio experience perceived as now since the functioning of the product and the human experience have a common RP as filed thus output of product and input for human experience via perception/feel/interaction/s are caliberated).

Further, customized audio for various sized cinemas can be also achieved where the cinema hall/home theatre is also made coherent for the cinema experience by standardizing the size of the cinema similar RP hall/creating acoustics/creating audio system and seating plans and so on can all be made more efficient or immersive or coherent and so on in keeping with the filed RP. This is simply an example. Further another example could also be one where line based audio frequencies could be placed from one direction to the listener and circular based frequencies could be made to fire from another direction towards the listener and those that are a mix of the two could be placed from another position/point to the listener. This could also be done at the level of creating such phase relationships from one box or more than one box and so on. This is all possible due to the RP and orientation based understanding of the human energy system complimented with new human vector based functioning as derived from the sports action and so on, that is aimed essentially at injury prevention/reorganization of energy and functioning for efficiency at the level of other (external) energy to interact with human energy and thus calibration has been achieved for human and environmental energy relationship/interactions with regards to the highest parameter (intelligence) and the most subtlest of parameter (perception) has been all calibrated within the RP and thus from emotions or geometry of animation to building products that deliver a deeper or more coherent perceptional experience are all catered to within the RP and thus within the system that sprouts from it. While some of these concepts might seem subjective, it is actually not so and human efficiency can and has been standardized by the RP's that can be derived from the present filing. (Thus, other RP can also be achieved from nature to create other products, such as flight of birds/music and so on.) Such a human efficiency based RP being mentioned here creates a perceptional/memory shift that removes old designs or old memories or habits/functioning and allows for new and more efficient versions/possibilities of function to be achieved and this can be repeated multiple times to arrive at various levels of form for efficiency or aesthetic or unique form and or function and so on. Further the RP essentially places multiple infinities placed harmonically so that the phase and polarity relationships are coherent or efficient for function and thus it is easy to imbibe or create deviations from the same as they can be done cleanly and largely predictably due to RP based upon human biomechanics for static and dynamic actionso as to prevent one from going too far away from the function/priority to be achieved. Thus by creating a design system based upon a RP that co relates to human geometry for evolution many steps in the path of human evolution can be explored and thus this can be also adapted for animation or toys and security systems & so on. The example given here is to show the coherence of the RP across the various platforms it can be applied and where it is sourced from and why it is important etc.

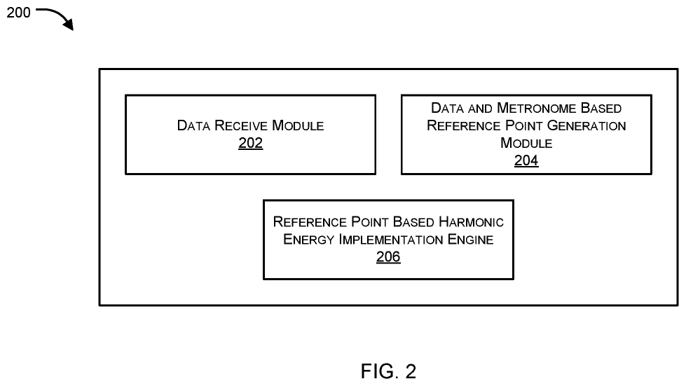

FIG. 2 illustrates exemplary functional modules 200 for enabling derivation of reference point in accordance with an embodiment of the present disclosure. In an aspect, the present system 200 can include a data receive module 202 that can be configured to receive data at a computing device, said data being related to actions and/or orientations of a user, and wherein the data can either be obtained in real-time from the user, or after a defined time interval or can be pre-stored or simulated. Any other manner in which data pertaining to actions/orientations of a user can be obtained is completed within the scope of the present disclosure. In an aspect, data can be obtained using one or more sensors (such as accelerometers, gyroscopes, phase meter etc) that can be operatively coupled with the user can be continuously sent over a network/communication medium.

The system 200 can further include a data and metronome based reference point (RP) generation module 204 that can be configured to, using one or more processors configured in a computing device in which aspects of the proposed system 200 is implemented, process the received data from module 202 with respect to a metronome so as to generate the RP.

In an exemplary implementation of module 204, user can have a data device/sensor that can be configured on his/her wrist/head/foot and can be operatively coupled with the metronome in a manner such that when the user performs an action/orientation (or an orientation based action), data is generated and transmitted by the data device and the metronome is calibrated to the action tempo, thus giving the tempo/data of the action performed. RP can accordingly then be derived from the tempo where stresslessness (positive energy polarity) is achieved for the action performed.

In another aspect, action of the user received by the metronome helps calibrate tempo of the metronome to the user's repetitive action, thus calibrating the metronome to the user's tempo. Data can therefore be derived for the RP or other RPs so as to improve for most ideal RP.

System 200 of the present disclosure can further include reference point based harmonic energy implementation module 206 that can be configured to, using the one or more processors, enable achievement of the reference point by the user during the action/orientation that enables creation of shortest path for energy delivery with positive polarity. In an aspect, module 206 can further be configured to enable the reference point to used for deriving a tempo, wherein time signature of the tempo can be changed in a linear fashion, and wherein the change in the time signature in the linear fashion can allow for the orientation/action to be broken down into a plurality of steps within the same tempo, and wherein sequential increase in the time signature with reference to the tempo and with reference to the completed action signifies a phase-relationship of energy flow.

In another aspect, the derived tempo can be used as a training reference for creating computer-enabled programs with variations to exercise patterns and/or training tempo for one or more levels of training for learning and improving form and function. In yet another aspect, the tempo can be inter-sectional or vector-based.

In an aspect, phase relationship created by the positive polarity enables a repeatedly efficient form and function that allows for energy/phase relationships to be manipulated/re-routed for a desired application.

In another aspect, the data can pertain to any or a combination of a sporting action, musical action, fitness based action, and physiotherapy based action.

In an aspect, the reference point can have a value of 88 bps (beats per second), wherein the RP can be used to help derive a fundamental unit for a product design application, and wherein the product design relates to any or a combination of sporting product, a fitness product, an ergonomic product design, a vehicle design, a sound and light equipment design, a furniture design, an interconnecting device design, an antenna design.

In an aspect, the RP provides a seamless interaction between a user, equipment, and machine and design.

In an exemplary aspect, the proposed system can be implemented in a physiotherapy based action, wherein user/doctor can perform one or more actions such as based on which when synchronization is performed using a metronome, an RP value of 88 is obtained. While one achieves a stressless RP (complete/efficient delivery of force/energy) based physical action repeatedly, one realizes that such an action provides a certain tempo of/for completed action which could be principally without stress or fatigue build up or could have a certain degree of stress or fatigue, resulting for the human activity.

In an aspect, it is desirable to use the action of least stress build up in the body, wherein, for instance, punching action of Bruce Lee can be used from the martial art of JeetKhun Do and can further be enhanced to eliminate stress by using line/open based orientations of the punching arm and foot respectively to derive the tempo which happens to be 88 BPM as measured by the metronome for each repeated completed action. Thus, using the tempo the action in full or in part or broken down could be used to back track such a stressless action within the derived tempo where the completed action is referenced to/considered as 1 for the completed action position. From this point, the tempo could be kept the same and the time signature could be progressed linearly to see the relationship of the action to the time signature of two and how much of the action can be achieved in a stressless or efficient manner. This reveals that the number two allows only for the back and forth movement of the arm with regards to energy deliver as achieved by the reference point of one, meaning completed action and or efficient delivery of energy, for the action being performed. Thus, it also needs to be said that rhythmic functioning is recommended and actions are to be performed musically or rhythmically so as to standardize the approach as regards such an inquiry. Thus, moving the time signature to three or four, and fitting the efficient rhythmic action of the person to the same tempo of 88 bpm allows for more variables to be introduced like the leg and the forwards or backwards stepping so as to allow for the action to be completed from its completed and “flexed” point to the ready or relaxed position and allow for the breathing of the user to play a bigger role in the application of the action and allow for understanding how the breathing affects the delivery or expulsion of force, and this is supported by the impulse action of the chosen action as well which brings clarity of relaxed and stressed or flexed states. While the number 4 allows for a rest with the completed action from this point, one can either continue with the same side for the practice of the punching action or change sides and perform the referenced action for the opposite side of the body as one goes to higher numbers, where number 8 becomes the point of completion of the action for both sides in keeping with the tempo of 88. The practice can be applied to higher numbers as well and they tend to apply for creating progressions after the first level of completion that is at 8. The higher numbers for sports relate more to preparation and starting, like a service for tennis etc. Thus, the energy or delivery of force achieved can be tested to generate results in a sport of tennis to check for the results generated such as, for example, average number of correct shots vs incorrect shots/results generated and thus energy polarity can be monitored at/from various points of the body of the player such as, for example, halfway point or centre of gravity of the body for each orientation action and could be done for completed action or in other ways. This reveals the relationship of numbers due to the time signature change and functioning of energy referenced to positive harmonic infinity or stresslessness. This reference is then useable by reducing the numbers to create products that are referenced to a functional goal or generally made with regards to energy efficiency based functioning or design. A foot orientation device that is referenced to 6 is made in two parts where a circle and an oval shape are matched to work together to allow for a foot orientation device to help a student learn his centre of gravity and how it changes when feet are in open or closed or centered orientation. The same can also done for another shape, say that of “X”. Flooring and false ceiling, lighting designs can also be included as examples of how space can be managed coherently for design by using this system of design. It needs to be understood that while the reference here is given of eight, it is a reference and can work with other numbers to derive their nature for the function that is required to be achieved. Thus, a number can be divided by 8 to derive it's energy functional/behavioral traits as referenced to a “completed action”. Thus, higher numbers can also be considered and numbers can be divided by eight to show their general energy or space behaviour/s. This can further be used where such functioning derived could be multiplied by a number whose functioning nature is desired energetically. Thus, aesthetics or hypnotic nature of the system of design can be kept intact through various applications and thus the references can be used to keep integrity of design through various numbers and so on. We also get two complete references from 88 when we reduce it i.e. 11 and 8, which shows variables/components/relationship for such a reference point and 10 is another number that holds similar reference once it is understood that 8 is a fundamental number and thus 8 and 10 also provides similar reference where multiplication of 8 by 10=80 which is still a fundamental of the reference point derived that is 88. Further, unit distance between orientations reference points can also be derived such as where one orientation is having a reference point of 70 and another RP orientation is at 88 and thus their basic rounded off difference is 18 units while further refining the same can also be done where a decimal point precision is achieved. Further, using the references as a starting geometry where visually/aesthetically/etc. decisions are made to create an initial geometric shape can be the starting point from where adjustments/additions can be made in keeping with the RP system or the RP's can also be approached. Further, scaling the RP based design can also be achieved by reducing/increasing a design from one orientation based RP to another RP. Further merging of two different RP's can also provide a comparative approach from where designs can be derived for the priority of function or aesthetics and so on. Further, any implements part of or used by the user to achieve the function RP can also be analyzed to collect variables or variety of data of additional RP. While simple examples have been given here complex designs can also be attended to.

It is to be appreciated that RP of the present disclosure is determined using functional physics that calibrates energy functioning's with a common or ideal RP for Energy as a “common” parameter for function and form for (matter) product design mainly referenced to achieving harmonic phase and polarity relationships as a system that is scalable and adaptable for any and all type of application where energy functioning/s are in consideration. Thus, it is the RP which is what decides matters/issues as regards how design and energy interact (through geometary of design upon which energies flow). The proposed RP unifies maximum parameters that are required from where other RP could be referenced or created based on effects of environmental interactions/force delivery or interaction quality/efficiency based organization of maximum variables/etc and also the combined resulting interactions of energy and force/s for a particular design where energy or functional physics as regards energy phase/polarity is not kept to a RP that is harmonic or happens to contain dissonance or lack of integrity becomes the final output of the product design which eventually is the cause of out of proportion pollution/breakdown/etc. Thus, a RP system for deriving the most efficient RP and the use or impact of other RP's in relation to the harmonic/efficient RP needs to be understood especially with regards to energy interactions based on highest level/s of efficiency for design of products, (especially, with a RP that takes into consideration human functioning as well within the RP), Such related other RP's (to ideal RP) need to be created so as to understand their impact upon (comparatively) the most efficient RP so as to be able to utilize or adjust them in various ways, such as for aesthetics or their particular type of function such as for example designing a component/space within a component that is capable of adjusting for the excessive energy/matter input in such a way that the excessive energy/matter does not become stagnant or chaotic or is presented efficiently for utilization when the need comes up. This could mean that excessive fuel is handled by a piston/pump in a way where it does not present excessive fuel for burning than is required. Thus by using the most efficient RP and understanding the functioning's of other RP in relation to the most efficient RP the entire pallet of RP's is made available to compliment the fundamental/most efficient/stress-less RP & one is able to create the RP in reference to which all other variables/progressions/customizations can be considered or explored and the relationship between aesthetics and functional physics can be derived as aesthetics/artistic decisions can be made more efficient by using even other RP and the function they present (that are part of/in relationship to the RP filed here and have their functioning based or derived from the most efficient RP filed here, thus being a system) that are having a harmonic relationship to the most efficient/stressless RP. Here the same RP system has been achieved for product design with the reference of/to human energy functioning by creating a Bio-mechanichal RP of highest efficiency that affects form/function/intelligence/energy and thus the same has been presented to the computational device for adapting this science/data for various fields and thus various applications so as to create data/theory/research/products/product designs and so on that are referenced (RP) to the human & matter/material performance in reference to efficiency and how efficiency with intelligence creates progressive form and function or to put it simply evolution in a repeatable and goal oriented way. Thus a RP system to resolve what can be in principle simply explained as “energetic chaos” has been proposed that allows for this problem to be resolved by, for example, considering maximum number of variables& harmonizing them so as to first derive the most efficient RP and also presents itself as the RP/reference system achievable for all types of designs that allow for the various multiple issues to be resolved that allow/cause for inefficiency to creep into the design functional physics. Thus, by correcting energy flow functionings (energy) which is a common factor upon which everything is based (human/matter/environment/intelligence/etc), a system to make everything seamlessly interactive and commonly efficient is filed by inventing what can be called a stressless RP's. Thus ergonomics/etc and product design are perfectly calibrated thru the RP since the data is derived from human bio-mechanical efficient action which also prevents injury & creates positive sports results and has the ability to reorganize form for function &etc. for more efficiency or higher integrity. This is thus ideal for products meant for human interaction at various levels such as safety/ergonomics/design appeal/responsive products/etc. while also happens to work with natural forces in an intelligent/organized manner. Thus, a common system of designing products is required that especially relates to the energy handling/functioning of products and their design not only to improve overall efficiency of products, their interactions with human senses but also with regards to interconnectivity and communication between them and their extensions and add ons and progressions and so on. Thus, when a common RP is achieved/created for humans and products the understandings of the environment/nature and it's energetic behavior/relationships could also be derived, since human is not out of nature and has the aspect of intelligence also included and approachable in his variables, the system is capable of organising intelligence from the same RP of positive harmonic infinity, which is an aspect earlier not applied as a common RP. Thus, a RP system that manages energy between humans and products and in fact also the environment in an increasingly efficient way is being presented asthetics. It needs to be understood that the RP for the design of a product and the resulting here shape or or looks does impact the environment in various ways. Thus, reduction of pollution and energetic chaos or even visual chaos is also a parameter to consider while choosing the RP for the designing of products. Thus, design for the RP filed would be better in performance while possibly consuming less energy and further utilizing available energy with higher efficiency thru all parameters/variables. Thus, a RP that allows for the integrated “science of everything” to be approached is a need of the hour to simplify training/manufacturing/designing/increasing sales/etc. The need to achieve this integrated RP with increasing coherence allows for all parameters to eventually be able to brought into alignment/calibration or adjusted to the RP and this could be done for various parameters (energy/intelligence/geometry/etc) however the goal or RP of efficiency for any business should or would not change as regards the design of their products nor would the responsibility of the human towards his own positive health or the health of the planet. Thus products and human performance/experience are ideally matched thru the RP filed, while earlier such coherence was not possible. Thus further, the integration of parts of a product or a circuit and so on even if within a product have earlier had a lower level of efficiency as different components are made to different RP whether mechanical or electrical and so on. Thus, with a RP that is stable and fairly predictable across many variables and calibrates them and is predictably stable for the same, makes better not only the energy transfer or the wasted energy or prevention of destructive or disharmonic energy and so on is reduced & even the type of symptoms that come up in extensions or add on or connected/interacting devices of products are reduced, such as for e.g. where the light to the screen does not meet the screen with the correct polarity or the screen does not meet the light with the correct polarity or phase or the screen does not present the correct polarity to the viewer or a speaker box is designed incorrectly or an amplifier goes through a breakdown due to generation of excessive heat due to the energetic chaos due to its functioning or space within a car is not optimally comforting or the engine and design do not match coherently and thus engine is required to generate excessive energy to compensate for incorrect design and causes more pollution than required for a particular function and so on. Thus, the RP presented allows for creating the function of products so as to be able to create phase variables thru the use of RP for design or energy orientation/s which helps keep these phase/polarity relationships aligned or harmonic during the design process while creating asthetic progressions that are also complimentary to the design/human experience/human senses/feel/etc as well while still being of the highest functionings. Further the RP can help reduce for e.g. e-smog since products will cause less energetic chaos and send and receive signals will be better handled by the hardware/etc. Thus to put it simply the RP filed is simply a way for getting majority (all) of the variables right at the stage of design largely and thus helps reduce costs as well as compensations are mainly replaced with choices during design. Thus further RP's could be derived keeping the goal of stresslessness and harmonic energetic action for many variables for various sports and so their RP could also be derived so as to make products suitable for application, such as making a ball or shuttle neutral to all orientations so as to prevent unfair advantage to a particular player who plays with a particular orientation while making racquets or bats based upon particular orientation or mix of orientations with a particular orientation as a priority for the player who has a particular orientation that he wishes to use as his main strategy during play. Thus the RP could be used for designing shoes. Further the RP could be derived while/for dynamic or in static position also so as to reduce number of variables and get clarity and precision and variety of data depending upon the query under consideration.

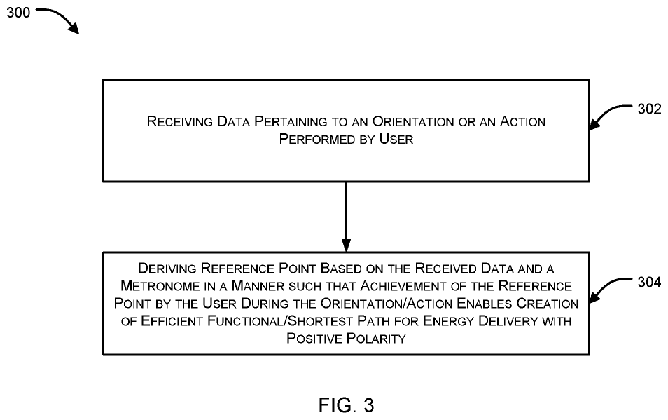

FIG. 3 illustrates an exemplary flow diagram300 for enabling derivation of reference point in accordance with an embodiment of the present disclosure. At step 302, the method can include receiving, at a computing device, data pertaining to any or a combination of an orientation or an action performed by the user by means of at least one sensor configured on the user; and at step 304, the method can include deriving, at the computing device, the reference point based on the received data and a metronome in a manner such that achievement of the reference point by the user during the orientation/action enables creation of shortest path for energy delivery with positive polarity.

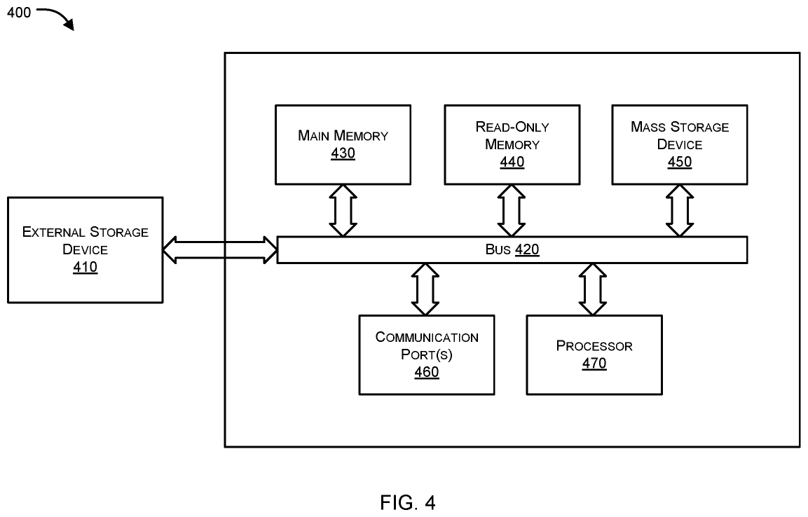

FIG. 4 illustrates an exemplary computer system 400 in which or with which aspects of the present disclosure can be implemented. As shown, computer system 400 comprises a bus 430, a processor 405, communication port 410, a main memory 415, an external storage device 440, a read-only memory 420 and a mass storage device 425. Computer system 400 may comprise more than one processor and communication ports. Examples of processor 405 comprise, but are not limited to, an Intel® Itanium® or Itanium® 2 processor(s), or AMD® Opteron® or Athlon MP® processor(s), Motorola® lines of processors, FortiSOC™ system on a chip processors or other processors. Processor 405 may comprise various modules associated with embodiments of the embodiments herein. Communication port 410 may be any of an RS-232 port for use with a modem based dialup connection, a 10/100 Ethernet port, a Gigabit or 10 Gigabit port using copper or fiber, a serial port, a parallel port, or other existing or other ports. Communication port 410 may be chosen depending on a network, such a Local Area Network (LAN), Wide Area Network (WAN), or any network to which computer system 400 connects. Memory 415 may be Random Access Memory (RAM), or any other dynamic storage device commonly used. Read-only memory 420 may be any static storage device(s); e.g., but not limited to, a Programmable Read Only Memory (PROM) chips for storing static information; e.g. start-up or BIOS instructions for processor 405. Mass storage device 425 may be any type of mass storage solution, which may be used to store information and/or instructions. Exemplary mass storage solutions comprise, but are not limited to, Parallel Advanced Technology Attachment (PATA) or Serial Advanced Technology Attachment (SATA) hard disk drives or solid-state drives (internal or external; e.g., having Universal Serial Bus (USB) and/or Firewire interfaces) , and one or more optical discs, Redundant Array of Independent Disks (RAID) storage; e.g. an array of disks (e.g., SATA arrays). Bus 430 communicatively couples processor(s) 405 with the other memory, storage and communication blocks. Bus 430 may be, e.g. a Peripheral Component Interconnect (PCI)/PCI Extended (PCI-X) bus, Small Computer System Interface (SCSI), USB or the like, for connecting expansion cards, drives and other subsystems as well as other buses, such a front side bus (FSB), which connects processor 405 to a software system. Optionally, wire operator and administrative interfaces; e.g. a display, keyboard, and a cursor control device, may also be coupled to bus 430 to support direct operator interaction with computer system 400. Other operator and administrative interfaces may be provided through network connections connected through communication port 810. External storage device 440 may be any kind of external hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM). Components described above are meant only to exemplify various possibilities. In no way should the aforementioned exemplary computer system 400 limit the scope of the embodiments herein.

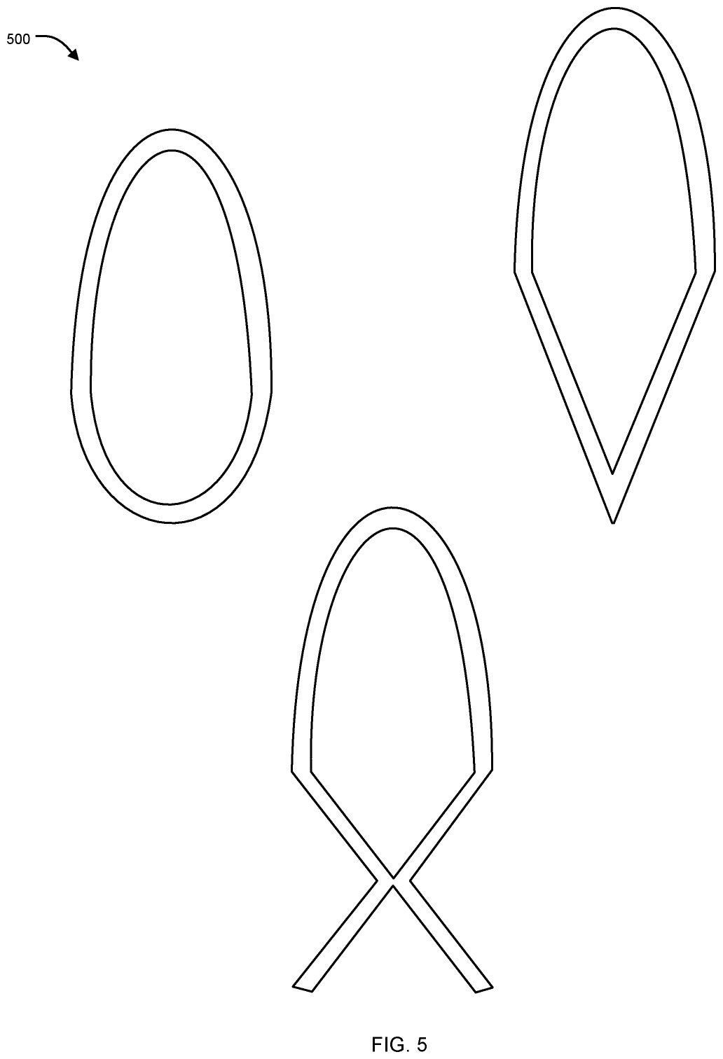

FIG. 5 illustrates an exemplary product that has been developed based on reference point computation in accordance with an aspect of the present disclosure. In this exemplary and non-limiting implementation, based on the RP of completed action of the number 8, functioning of number 6 was derived and thus product was designed for the same function to be achieved for the user. In this case, the product is configured to allow/understand posture affected by different orientations and compensation/adjustment required to achieve common center of gravity, which helps sports person or patient to function efficient for orientations.

While embodiments of the present disclosure have been illustrated and described, it will be clear that the disclosure is not limited to these embodiments only. Numerous modifications, changes, variations, substitutions, and equivalents will be apparent to those skilled in the art, without departing from the spirit and scope of the disclosure, as described in the claims. All such modifications, changes, variations, substitutions, and equivalents are completely within the scope of the present disclosure. The scope of the invention is determined by the claims that follow.

Moreover, in interpreting both the specification and the claims, all terms should be interpreted in the broadest possible manner consistent with the context. In particular, theterms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

### Advantages of the Invention

The present disclosure provides a system and method that enables generation/derivation of a reference point (RP).

The present disclosure provides a system and method that enables use of the RP to enable harmonic energy based action by a user.

The present disclosure provides a system and method that enables use of the RP in a harmonic energy implementation system.

The present disclosure provides designs for products in keeping with the reference point so as to create medical/physiotherapy/sporting/artificial limb/organ products.

The present disclosure provides designs for products that apply the RP for creating new products and technology especially for clean energy/free energy/perpetual energy/efficient energy.

The present disclosure provides products that can be made to harmonize with chaos theory or butterfly effect or at-least make it efficient and allow for analysis of the same and associated parameters.

The present disclosure provides products that allow for analog to digital conversion and digital to analog conversion to be optimized along with processing for the analog/digital/domain based functioning.

The present disclosure provides products that form parts of products to be made harmonized for form and function and energy and intelligence (safety/etc.).

The present disclosure provides that enable creation of medical data and corrections and make precise medical concepts and data as regards the various relationships between musculoskeletal/biomechanical/mental/energetic/intelligence relationships with regards to efficiency and their reorganization/reorientation/s and thus reflecting in human experience/relationship to time and memory and so on.

The present disclosure enables scaling up and down of the RPas regards matter/energy/intelligence/etc and it's organization for various application/s.

The present disclosure enables creation of a system to manage timing and resulting issues from errors or lag in/for the same.

The present disclosure enables creation of various RPs through analysis of data provided/derived.

The present disclosure enables standardization of products and components for increased efficiency.

I claim:

1. A method of deriving a reference point and using said reference point to enable harmonic energy based action by a user, said method comprising the steps of:
receiving, at a computing device, data pertaining to any or a combination of an orientation or an action performed by the user by means of at least one sensor configured on the user; and
deriving, at the computing device, the reference point based on the received data and a metronome in a manner such that achievement of the reference point by the user during the orientation/action enables creation of shortest path for energy delivery with positive polarity.

2. The method of claim 1, wherein the orientation is any or a combination of foot orientation, hand orientation, punching pathway orientation, shot-making pathway orientation, and energy orientation.

3. The method of claim 1, wherein the action is any or a combination of punching action, hand-based action, body-based action, and foot-based action.

4. The method of claim 1, wherein said reference point is used for deriving a tempo, wherein time signature of the tempo is changed in a linear fashion.

5. The method of claim 4, wherein the change in the time signature in the linear fashion allows for the orientation/action to be broken down into a plurality of steps within the same tempo.

6. The method of claim 4, wherein sequential increase in the time signature with reference to the tempo and with reference to the completed action signifies a phase-relationship of energy flow.

7. The method of claim 4, wherein the derived tempo is used as a training reference for creating computer-enabled programs with variations to exercise patterns and/or training tempo for one or more levels of training for learning and improving form and function.

8. The method of claim 4, wherein the tempo is inter-sectional or vector-based.

9. The method of claim 1, wherein phase relationship created by the positive polarity enables a repeatedly efficient form and function that allows for energy/phase relationships to be manipulated/re-routed for a desired application.

10. The method of claim 1, wherein said data pertains to any or a combination of a sporting action, musical action, fitness based action, and physiotherapy based action.

11. The method of claim 1, wherein the reference point value is 88 bpm.

12. The method of claim 1, wherein the reference point is used to help derive a fundamental unit for a product design application.

13. The method of claim 12, wherein the product design relates to any or a combination of sporting product, a fitness product, an ergonomic product design, a vehicle design, a sound and light equipment design, a furniture design, an interconnecting device design, an antenna design.

14. The method of claim 1, wherein the reference point is used for training users with respect to their actions and/or orientations.

15. The method of claim 1, wherein said data is simulated data.
